(19) United States
(12) Patent Application Publication
(10) Pub. No.: US 2004/0058036 A1
(43) Pub. Date: Mar. 25, 2004

(54) Compositions and methods relating to frozen dough products

(76) Inventors: Annavarapu S. Murty, Spring Valley, WI (US); Lisa M. Stoiber, St. Louis Park, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/253,333

(22) Filed: Sep. 24, 2002

(51) Int. Cl. A23G 3/00

(52) U.S. Cl. 426/95

(57) ABSTRACT

Described are methods and compositions relating to dough products, especially dough products that are frozen or intended to be stored as frozen, including methods and compositions that involve the use of relatively low average particle diameter size (e.g., below 165 micron) edible powders to reduce or prevent sticking between frozen dough composition surfaces.

### FIELD OF THE INVENTION

The invention relates to dough products, specifically including frozen dough products packaged and frozen to have contacting dough surfaces, where an anti-stick material is disposed on one or more of such contacting surfaces.

### BACKGROUND

Frozen pre-formed dough products are increasingly popular among consumers due to the convenience and storage stability of such products. Frozen dough products include frozen biscuits, frozen pie crust, frozen pizza doughs, frozen bread doughs, as well as others. Many (though not all) frozen dough products can be prepared straight from the freezer to the oven, without thawing or proofing. It is expected that the popularity of frozen dough products will remain strong and even increase.

A problem with frozen dough products can be that surfaces that are in contact during storage can stick together and be very difficult if not impossible to separate. This tendency to stick or “clump” can occur where one surface of a dough contacts another surface and is frozen there, e.g., if a pie crust is folded over to contact itself and frozen, or if multiple dough portions are packaged together and frozen, such as biscuits. Biscuits placed together within a single package, in contact with surfaces of other biscuits, can become frozen together and inseparable, either destroying the product or causing the user to become frustrated. It appears that clumping problems are exacerbated if packaged frozen dough products are thawed and re-frozen during transport or storage, especially if cycles of freezing and thawing occur multiple times.

Various attempts have been made to prevent surfaces of dough materials from sticking together, including the use of rice flour, e.g., having average particle diameter of at least 165 microns, at surfaces of frozen biscuits. See also U.S. Pat. No. 3,397,064, which describes rice flour to separate pressurized refrigerated biscuit dough. The use of rice flour with refrigerated pie crusts is described in U.S. Pat. No. 5,270,065.

### SUMMARY

The invention involves the discovery that edible powders having relatively small average (i.e., “mean”) particle diameters, 160 micron or less, when placed between dough surfaces, can be especially useful to reduce the tendency of those dough surfaces to stick together when frozen. According to the invention, it has been surprisingly found that the average diameter of particles of edible powder used in or as an anti-stick material for frozen doughs can be selected to provide surprisingly improved anti-sticking and anti-clumping properties. Preferred average particle diameters have been found to be from 5 microns to 160 microns, preferably from 5 microns to 90 microns, and more preferably from 5 microns to 50 microns or from 5 microns to 40 microns.

Other factor relating to an edible powder particle size (diameter) profile can also be useful in describing preferred particles for use according to the invention, such as median (i.e., “midpoint”) (as opposed to average or mean) particle diameter, 90 percent volume particle diameter, and 10 percent volume particle diameter. As used herein, median and midpoint particle diameters are defined as the diameter of a sample of particles that places 50% of the particles in the sample to have a greater diameter than the median (midpoint), and 50% of the particles in the sample to have a diameter less than the median (midpoint). Certain embodiments of the invention can include an edible powder having one or more of a midpoint particle diameter in the range from 5 microns to 160 microns, preferably from 10 microns to 90 microns, more preferably from 10 microns to 50 microns or from 10 microns to 40 microns; a diameter of 90 percent by volume of the powder particles of less than 320 microns, preferably less than 70 microns; and a diameter of at least 90 percent by volume of the powder particles of greater than 5 microns.

The edible powder may be any type of edible powder material such as a flour or a starch that has an average particle diameter as described, optionally having a preferred particle size profile including one or more of the described median particle diameter, 90 percent diameter, or 10 percent diameter. Examples of useful edible powders include flours such as high gluten flour, soft wheat flour, hard wheat flour, rice flour, semolina flour, and others; starches including cornstarch (e.g., re-dried cornstarch), potato starch, wheat starch, instant cornstarch, tapioca starch, modified wheat starches, and corn starches; powdered vegetable shortening; sodium silicoaluminate; and carboxy-methylcellulose.

According to the invention, edible powder as described may be used to prevent sticking or clumping of any type of frozen dough product. Preferred product embodiments according to the invention can relate to frozen biscuit products, e.g., loosely packed or packaged frozen biscuits. It is understood, however, that the invention is applicable to other types of frozen dough products that would benefit from not sticking to another material such as another dough surface, especially flat dough surfaces, so that the dough product can be easily separated from that other surface without damage to the dough composition. For example, the invention could be used to prevent or reduce sticking or clumping of a frozen pie crust surface to another frozen pie crust surface, e.g., a folded surface of the same crust or a surface of a different crust. Similarly, the invention would be useful to separate frozen pizza crusts, frozen bread doughs, and the like.

In preferred embodiments, the presence of edible powder having an average diameter in the range from 5 microns to 160 microns between frozen dough surfaces has been shown to provide improved resistance of frozen surfaces from sticking together, e.g., as compared to the use of powder having larger average particle diameter (165 microns or greater). Any comparative method can be used to identify powders of the type described herein, having particle size useful to reduce sticking between frozen dough surfaces, and such techniques will be appreciated and available to those of skill in the frozen dough and baking arts. According to one test methodology, dough surfaces in contact with each other are subjected to multiple (e.g., up to 7) freeze/thaw cycles, by alternately exposing the dough to below-freezing and above-freezing temperatures to cause the dough to alternatively freeze and thaw. Compositions described herein that use anti-stick materials containing edible powders having average diameters in the range from 5 microns to 160 microns, at contacting surfaces of frozen dough compositions, have been observed to exhibit less clumping compared to similar dough compositions that use anti-stick materials having larger average diameters. Less clumping means, for example, that after multiple (e.g., 3 to 7) freeze/thaw cycles, the inventive frozen dough compositions could better be separated compared to frozen dough compositions using larger average particle diameter edible powder as an anti-stick material.

The invention relates generally to frozen dough products and related methods that use relatively small diameter particles, e.g., from 5 microns to 160 micron, especially from 5 micron to 90 micron and more preferably from 5 microns to 50 microns or 5 microns to 40 microns average diameter particles, as anti-stick materials for frozen dough surfaces. Such edible powder, when present at a surface of a frozen dough composition such as a biscuit or pie dough, can reduce the tendency of the contacting dough surfaces to stick together when frozen and after freeze/thaw cycles.

Edible powder may become disposed at a surface of a dough composition by any useful method. Preferably, edible powder may be placed on one or more surfaces of a dough composition or portions thereof, e.g., by coating the edible powder, by itself or with other materials, using any technique such as a well known technique of spraying, dusting, or tumbling. This step may be done before or after freezing.

Edible powder may be applied alone and used alone at one or more surfaces of a dough composition to reduce or prevent sticking between frozen dough surfaces. One or more different types of dry edible powder can be applied by a known method of applying a dry or powdered composition to a dough surface. Alternatively, a dry powder may be applied in a wet and dry system by combining the powder with a liquid, preferably an edible liquid such as a room temperature liquid oil or a melted room temperature solid shortening. As an example, liquid can first be applied to a dough piece and then the dry powder particles may be coated over the liquid.

One or a combination of different types of dry edible powders can be applied to a dough surface with no other materials, to prevent sticking. Or, one or a combination of different types of edible powders can be combined with another material such as a liquid fat or oil, and then applied to a dough surface. According to one method, a small amount of an oil or fat can be contained in the edible powder, and the combination of fat or oil and powder can be applied to a surface of a dough composition prior to or after freezing. The oil can preferably and advantageously act as an “anti-dusting” agent for the edible powder, i.e., the liquid can reduce or prevent the tendency of the powder to form a cloud of dust during processing, which could become a safety hazard or which could simply cause waste or difficulty in applying the powder to a dough surface.

An aspect of the invention relates to a method of preventing contacting surfaces of frozen dough from sticking together. The method comprises disposing an anti-stick material on one or more of the contacting surfaces, the anti-stick material comprising edible powder having an average particle diameter in the range from 5 microns to 160 microns.

Another aspect of the invention relates to a frozen food product comprising two contacting dough surfaces. One or more of the surfaces comprises anti-stick material comprising edible powder having an average particle diameter in the range from 5 microns to 160 microns.

Yet another aspect of the invention relates to a frozen dough-product. The dough product comprises dough composition, and edible powder disposed on a surface of the dough composition to reduce sticking between the surface of the dough composition and another surface of dough composition. The edible powder has an average particle diameter in the range from 5 microns to 160 microns.

Yet another aspect of the invention relates to a method of preparing a frozen dough product. The method comprises preparing a dough composition, and disposing anti-stick material comprising edible powder on one or more surfaces of the dough composition. The edible powder has an average particle diameter in the range from 5 to 160 microns. The dough product is frozen before or after disposing the anti-stick material onto the surface.

### BRIEF DESCRIPTION OF THE FIGURES

FIG. 1 illustrates severity of biscuits sticking after 7 freeze thaw cycles.

FIG. 2 illustrates severity of biscuits sticking after multiple freeze thaw cycles.

FIG. 3 illustrates sticking of biscuits using different rice flour anti-stick materials.

FIG. 4 illustrates sticking of biscuits using different rice flour anti-stick materials.

### DETAILED DESCRIPTION

Edible powders useful in methods, compositions, and products of the invention include materials known in the baking and cooking arts or developed in the future, that take the form of particles having a desired particle size profile, including a mean or average diameter in the range from 5 microns to 160 microns, preferably from 5 microns to 90 microns, more preferably from 5 microns to 50 microns. Preferred powders can have diameter profiles that do not cause the product to be gritty, to have an undesirable flavor, or to appear to have a powdered coating, if too large of particles are used.

Particles in the stated size ranges, when present between surfaces of dough compositions, have been found to reduce the tendency of contacting dough surfaces, when frozen, to stick together, often to a surprising extent. While not wishing to be bound by theory, it is-believed-that the powder particles within the specified size ranges interact with surfaces of dough in a way that larger diameter particles do not. Specifically, relatively smaller average diameter (160 micron or less) particles have been observed to be picked up better by surfaces of dough compositions. It is theorized that the specified relatively small average diameter particles may interact with surface structures of a dough product by filling in or adhering to small surface structures (e.g., cracks) in a way that larger diameter particles cannot, and in a way that reduces the tendency of the surfaces to stick together when frozen, especially after multiple cycles of freezing and thawing.

As is understood, particles of a mass of powder such as the edible powders described herein generally do not have a uniform size, but have a particle size distribution that is of approximately a bell-curve profile. Other specifics of this type of size profile, besides average diameter, can also be considered with respect to the effectiveness of edible powder in preventing sticking between dough surfaces. For example, while not required, certain preferred edible powders for use according to the invention may exhibit any one or more of a mean particle diameter in the range from 5 microns to 160 microns, preferably from 5 microns to 90 microns, and more preferably from 5 microns to 40 microns; a diameter of 90 percent by volume of the powder particles of less than 320 microns, preferably less than 70 microns; and a diameter of at least 90 percent by volume of the powder particles of greater than 5 microns.

The type (e.g., composition) of powder particles can be any type of powder particle within the specified size range and profile, and that is useful with food products, e.g. edible. Many types of edible powders are well-known, including a variety of different types of flours, such as high gluten flour, soft wheat flour, hard wheat flour, rice flour, and others; a variety of different types of starches including cornstarch (e.g., re-dried cornstarch), potato starch, wheat starch, instant cornstarch, tapioca starch; dried shortenings such as powdered vegetable shortening; sodium silicoaluminate; and carboxy-methylcellulose. According to preferred embodiments of the invention, certain diameters of certain types of powders have been found to be particularly effective in preventing sticking of frozen dough products. In the particular example of rice flour, preferred results have been obtained by using-rice flour powder having a mean or midpoint particle diameter in the range from 5 microns to 90 microns, e.g., from 5 microns to 50 microns, or from 5 microns to 40 microns. For corn starch, a preferred midpoint diameter or mean diameter can be from 5 microns to 50 microns, e.g., from 5 to 20 microns.

The dough compositions that can be used according to the methods and products of the invention can be any dough compositions that tend to stick together or stick to another surface (e.g., a package), upon freezing. Examples include frozen food products that are packaged in a way that results in contact between dough surfaces, such as biscuits that are packaged and frozen while in contact with each other, as well as pie crusts, pizza crusts, bread doughs, and the like, that are packaged with contacting dough surfaces (e.g., folded pie crusts or stacked pie crusts, loosely or orderly-packed biscuits, etc.).

The ingredients of the dough composition can be of practically any useful variety of known or developed dough ingredients. Dough compositions generally include an amount of flour; oil such as butter, liquid vegetable oil, another type of liquid oil, solid shortening, or the like; an amount of a liquid component such as water; leavening agent such as yeast or effective chemical leavening agents; sweeteners or flavorings such as any of a variety of useful sugars or starches; and any of a variety of additives such as preservatives, conditioners, protein or gluten, egg or dairy products, etc. Biscuit and pie dough formulations are well known in the dough and bakery arts.

Dough compositions such as these can be prepared by well understood methods that include steps such as the following, possibly but not necessarily in approximately the following order: mixing dough ingredients in single or multiple stages; forming and shaping a dough composition by steps that include one or more of resting, lapping or folding, rolling, cutting, and filling, optionally with the incorporation of additional ingredients such as layers of fat or filling material; and optional resting, developing, and proofing steps to develop dough or allow dough to rise. Once prepared to a cut stage, such as a cut pie crust or a cut biscuit, the cut dough pieces (or “portions”) are generally assembled, frozen, packaged (not necessarily in that order), and then shipped. These assembly and post-assembly and packaging steps may cause surfaces of dough compositions-to contact each other, e.g., folding in the case of a pie crust, and loose packing or stacking in the case of biscuits.

Edible powder as described herein can be combined or added to or on a dough composition to prevent or reduce sticking, by any useful method, such as during or before or after any one or more of the above described steps for preparing a dough composition. By one method, edible powder can be placed on a surface of a dough composition that has already been prepared from its basic ingredients, and that has been partially or fully formed into a dough product or dough product portion, either before or after freezing. According to this method, a dough composition can be prepared by mixing its ingredients together and processing, e.g., including a sheeting, rolling, and/or cutting step, as would be done with biscuits or pie crust products. After rolling or sheeting, and before or after cutting, and before or after freezing, a non-stick material that includes the edible powder described herein can be placed at one or more surfaces of the dough composition, preferably at surfaces that will contact other dough surfaces upon packaging, for example top, bottom, and side surfaces (preferably all surfaces) of dough that will be in contact upon packaging. Optionally, the dough coated with anti-stick agent may be further processed by rolling to cause the anti-stick agent to better contact and stick to the dough composition.

Coating anti-stick material onto dough surfaces can be accomplished by any useful method, such as by spraying or dusting anti-stick material over surfaces of a dough composition, by brushing, by placing pieces of dough into a tumbler that contains anti-stick material and tumbling, and by the use of breading apparatus. Additionally, the anti-stick material may be placed onto a dough composition surface at any useful point in production prior to packaging. In one embodiment for use with frozen biscuits, biscuits can be formed, dedusted, frozen, and then coated with anti-sticking agent, optionally with a subsequent rolling step to press the anti-stick agent to the dough surface, followed by packaging generally in a loose, random configuration. Edible powder can be applied to a surface of a frozen or unfrozen dough composition as a material that contains edible powder by itself or in combination with one or more other dry or liquid materials. One method for applying dry anti-stick powder material is dusting, where the powder is sprinkled on one or more frozen or unfrozen dough composition-surface. Another method, tumbling, is a particularly preferred method of applying an anti-stick material onto a frozen or unfrozen dough composition surface.

The amount of edible powder applied to a dough surface can be an amount that will reduce the tendency of the dough to stick to another material (especially another dough surface), e.g., an amount of edible powder that will facilitate separation of the dough surface from another frozen dough surface, or an amount of edible powder that will reduce or prevent sticking between frozen dough surfaces after 2, 3, 5, or 7 or more freeze/thaw cycles. As specific exemplary amounts, anti-stick material containing edible powder of the desired average particle diameter, and optionally a small amount of oil as described herein, can be applied to two dough surfaces that will contact each other upon assembly and frozen storage, in amounts at each surface in the range from 0.1 to about 5 percent, preferably from 0.3% to 1.5% anti-stick material by weight dough composition, or from 0.01 to 0.05 grams per square inch of dough composition (for full coverage). On biscuits, for example, an amount of about 0.77% anti-stick material by weight biscuit may be used. Preferred amounts can be in the ranges from 0.5% to 0.8% anti-stick material by weight dough composition, or from 0.02 to 0.03 grams anti-stick material per square inch of dough composition. These amounts of anti-stick material include edible powder and optional oil, if used.

One method by which to obtain a useful or preferred coating weight can be to coat frozen dough compositions using a tumbler containing an excess of anti-stick material, e.g., an amount of anti-stick in the tumbler that is from 2 to 6 times the amount desired to be coated on the dough surfaces. The amount placed in a tumbler and the amount coated on a dough surface can depend on factors such as the type of dough, the type of anti-stick materials (edible powder and optional oil), the relative amount of surface area per mass of dough composition, etc.

In embodiments where the anti-stick material does not contain a small amount of oil to prevent dusting, the dough composition may be treated to pick up the dry powder anti-stick material, such as by coating with a liquid. As an example, a fat or oil may be first applied to a dough surface and then a dry edible powder can be applied by dusting, tumbling, or any other useful method.

In another embodiment, edible powder can be applied as a combination of edible powder containing a small amount of liquid to prevent dusting, such as a liquid oil or fat or another edible organic liquid. In this embodiment, oil can be present in the edible powder (e.g., flour) as a processing aid for the flour, and is often present in the flour from the flour's supplier. A liquid oil or fat can be particularly useful with lower range edible powder particles (e.g., from 5 micron to about 100 micron) to avoid or prevent dusting that can be associated with processing these smaller sized particles, e.g., applying powders of these smaller sized particles to a dough surface by dusting, tumbling, or spraying.

The liquid oil or fat can be a room temperature liquid fat or oil or a (melted) room temperature solid shortening, shortening chip, or fat, many examples of which are well known and commercially available within the cooking and baking arts. Specific examples of room temperature liquid or room temperature solid oils include liquid vegetable oils, corn oil, soy oil, peanut oil, coconut oil, palm oil, and the like; liquid or solid vegetable or animal shortening; and glycerin or other such low molecular weight polyols.

If a liquid oil or fat is included in an anti-stick material, i.e., in an edible powder as described herein, and applied to a dough surface, the relative amounts of edible powder and liquid fat or oil can be any amounts that allow placement of a useful amount of edible powder to the dough composition surface, i.e., an amount that can reduce or prevent sticking of a frozen dough surface to another surface such as another frozen dough surface; or a relative amount of oil per powder that can prevent dusting or facilitate sticking of the powder to a dough surface.

The specific amount relative amounts of powder and oil in an anti-stick material (which in this case refers to the oil and the edible powder) can depend on factors such as the type of oil, the type of dough or dough surface, the type and amount of edible powder, the size profile of the edible powder, etc, as will be appreciated and understood by one of skill. For soy oil used in rice flour, exemplary amounts of rice flour to soy oil can be in the range from about 0.5 to 7 parts by weight soy oil per total weight rice flour and soy oil. Useful amounts for any particular type of fat or oil or edible powder will depend on factors such as the chemistries and properties (e.g., viscosity) of the fat or oil or powder, particle size and distribution of the edible powder, the possible presence of other materials, etc.

### EXAMPLES

### Example 1

One of the main complaints of FTO (freezer-to-oven) biscuits is sticking or clumping in the package. A study was performed to consider application methods and ingredients to prevent sticking of frozen biscuits.

Materials & Methods:

The following ingredients were used as anti-stick materials:

Redried Corn Starch (average particle diameter 14 microns)

Wheat Starch (average particle diameter 21 microns)

Soft Wheat Flour (average particle diameter 32 microns)

Modified Wheat Starch (average particle diameter 40 microns)

Rice Flour (average particle diameter 164-174 microns)

Methods of Coating

Tumbling of Frozen Biscuits

Frozen Southern Style Biscuits packed in bulk were placed in a small pilot plant-scale tumbler with one of the listed coating ingredients. The biscuits were removed and packaged after they were completely coated. The tumbler was completely cleaned between ingredients, and the total weight of ingredient consumed was used to calculate how much ingredient was on each biscuit.

Dusting of Non-Frozen Biscuits

Southern Style biscuits were produced from dough using an extrusion method. A dusting ingredient was applied to the bottom of a moving belt before the dough was extruded onto the belt, and the same dusting ingredient was applied to the top of the sheeted dough before the biscuits were cut. Excess dusting ingredient was brushed off the top of the dough by hand. Biscuits were placed on a baking sheet and put into a blast freezer at −10° F. until frozen. Once frozen, the biscuits were packed into bags.

Packing

Six biscuits were stacked on top of each other and placed in clear plastic bags. The bags were then placed on their side and put onto a baking sheet. The sheets were then stored on baking racks in the −10 freezer.

Freeze-Thaw Study

All biscuits were removed daily from the freezer and allowed to thaw at room temperature until they reached 25-30° F.—approximately 2 hours. The biscuits were then placed back in the −10° F. freezer. Samples were evaluated the following day. The following evaluations were made:

# of biscuits in each clump

Severity of clumping on a scale of 0-5

0=no sticking

1=very easy to separate, takes no effort

5=unable to separate all the biscuits, failure

# of deformed biscuits per bag

Severity of deformation of frozen biscuits on scale of 0-5

0=no deformation

1=slightly deformed

5=highly deformed

Evidence of ingredient on the frozen biscuits based on a 0-5 scale

Six bags using each dusting ingredient were evaluated per freeze/thaw. A total of 7 freeze/thaw cycles were done. Sample sets were removed from the study when they reached a 5 on the severity of clumping scale.

SUMMARY OF FREEZE-THAW STUDY ON SOUTHERN STYLE BISCUITS-Severity of Sticking

| | Freeze-Thaw # | | | | | | | |
|---|---|---|---|---|---|---|---|---|
| | 1 | 2 | 3 | 4 | 5 | 6 | 7 | Comments |
| Control 1 (164-174 micron rice flour) | 1 | 4 | 5 | 5 | | | | |
| Control 2 (164-174 micron rice flour) | 2 | 3 | 5 | 5 | | | | |
| Tumbled Rice Flour | 1 | 1 | 2 | 3 | 5 | 4 | | Dough tore when separating in later freeze-thaws |
| Tumbled Soft Wheat Flour | 1 | 1 | 1 | 3 | 3 | 4 | 4 | |
| Tumbled Redried Corn Starch | 0 | 0 | 0 | 0 | 0 | 1 | 1 | Extreme excess, very messy! Flakes off biscuit |
| Tumbled Wheat Starch | 0 | 1 | 1 | 2 | 2 | 3 | 3 | Residue in bag |
| Tumbled Modified Wheat Starch | 0 | 0 | 1 | 1 | 2 | 2 | 4 | Dusty during processing, slight residue in bags |
| Dusted Rice Flour | 0 | 1 | 1 | 2 | 2 | 2 | 3 | |
| Dusted Soft Wheat Flour | 2 | 4 | 5 | | | | | Dough stuck to rollers during processing |
| Dusted Redried Corn Starch | 1 | 1 | 1 | 3 | 1 | 3 | 4 | Uneven coating on top & bottom, excess sticks to hands |
| Dusted Wheat Starch | 1 | 1 | 2 | 2 | 3 | 4 | 4 | Residue in bag |
| Dusted Modified Wheat Starch | | | 2 | 1 | 3 | 3 | 3 | Very dusty during processing |

Processing Notes:

The modified wheat starch caused dusting during application. Redried corn starch had difficulty passing through duster openings. Biscuits dusted w/soft wheat flour stuck to sheeter rollers, and scraper was used to remove from sheeter belt.

Discussion of Results:

Redried corn starch was the best ingredient in preventing sticking, followed by modified wheat starch and wheat starch. Corn starch and wheat starch are highly visible on the frozen biscuits.

Tumbled Frozen Biscuits

| | Amt. Added to | | | g/ |
|---|---|---|---|---|
| | Rumbler | Remaining | Used | biscuit |
| Rice flour | 300 g | 200.9 g | 99.1 g | 0.34 |
| Wheat Starch | 469.6 g | 144.4 g | 325.2 g | 1.13 |
| Redried Corn Starch | 511.4 g | 30.6 g | 480.8 g | 1.67 |
| Soft Wheat Flour | 407.1 g | 213.6 g | 193.5 g | 0.67 |
| Modified Wheat Starch | 416.8 g | 222.1 g | 194.7 g | 0.68 |

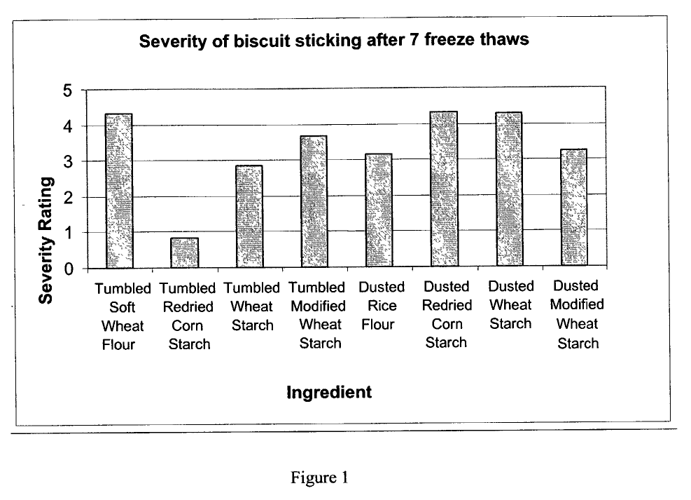

FIG. 1 shows severity of sticking after 7 freeze thaw cycles.

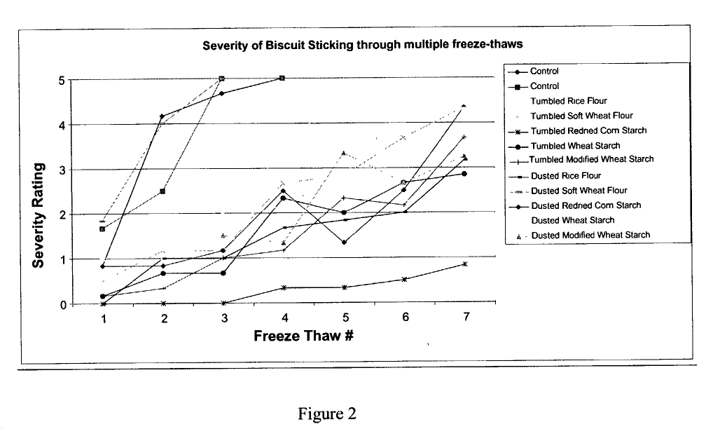

FIG. 2 shows severity of sticking through multiple freeze thaw cycles.

### Example 2

Objectives:

To monitor the Freeze/Thaw performance of SS biscuit samples with control rice flour (average particle diameter 165 micron) coating, smaller particle size (120 mesh, 90 micron midpoint diameter), even smaller (200 mesh, 30 micron midpoint diameter) and even smaller (200 mesh, 30 micron midpoint diameter) with ½% oil coating to minimize dusting in the process area. The control rice flour had difficulty achieving desired amounts of coverage. Finer granulation rice flour exhibit increased amounts of rice flour retained on biscuits.

Conclusions and Recommendations:

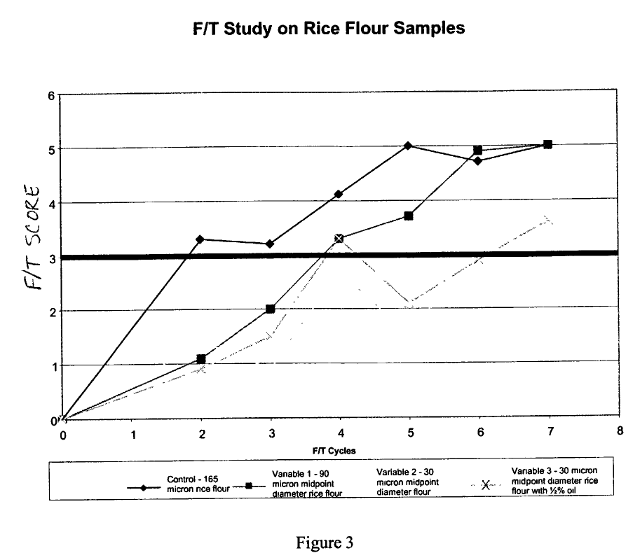

The study was concluded after 7 F/T cycles. The control lasted about 3 F/T cycles before the product was unacceptable (clumping score greater than 3 for an avg. of 4 bags). The 120 mesh rice flour sample (90 micron midpoint diameter) lasted about 4 F/T cycles and the 200 mesh (30 micron midpoint diameter) and 200 mesh with oil both lasted about 6 F/T cycles. See FIG. 3.

Materials & Methods:

Freeze—Thaw Study

All biscuits were removed daily from the freezer and allowed to thaw at room temperature until they reached 25-30° F.—approximately 2 hours. The biscuits were then placed back in the −10 freezer. Samples were evaluated the following day. The following evaluations were made:

# of biscuits in each clump

Severity of clumping on a scale of 0-5

0=no sticking

1=very easy to separate, takes no effort

5=unable to separate all the biscuits, failure

# of deformed biscuits per bag

Severity of deformation of frozen biscuits on scale of 0-5

0=no deformation

1=slightly deformed

5=highly deformed

Evidence of ingredient on the frozen biscuits based on a 0-5 scale

4 bags of each variable were evaluated per freeze/thaw. A total of 10 freeze/thaw cycles were done. Sample sets were removed from the study when they reached a 5 on the severity of clumping scale.

### Example 3

Conclusions and Recommendations:

The 200 mesh rice flour performed significantly better than the 165 micron average diameter rice flour. There was minimal clumping after 5 freeze-thaws.

Materials:

Southern Style frozen biscuit dough pieces (bulk packed)

Control Rice flour

200 mesh rice flour

Methods:

Biscuits were coated by hand. An excess amount of rice flour was put in a container. 6-12 biscuits were placed in this container, and the lid was put on top. This container was then shook by hand 3-4 times. Biscuits were removed from the rice flour and tapped together to remove excess flour. 12 biscuits were randomly placed into plastic zipper bags. 4 bags were set on a tray, and the entire set of trays was placed in the freezer before any freeze thaw testing was done.

A total of 5 freeze-thaws were performed on each sample set. For each freeze-thaw, the biscuits were brought to a temperature of 25-30° F. by holding at room temperature (˜65° F.). Temperature was measured after 1.5 hours and after 2.0 hours. The biscuits were placed in the freezer when they reached a minimum of 25° F. This was normally after 2 hours. They were placed in the −10° F. walk-in cooler overnight (approx. 22 hrs).

4 bags of product per variable were evaluated after each of the freeze-thaw cycles.

The following evaluations were:

# of biscuits in each clump

Severity of clumping on a scale of 0-5

0=no sticking

1=very easy to separate, takes no effort

5=unable to separate all the biscuits, failure

A weighted average for sticking was then calculated for each bag of biscuits.

Example: A bag with a clump of 5 biscuits, severity of 2 and 6 biscuits severity of 3 would have a final value of 2.3.

2.3=(5 biscuits*2+6 biscuits*3)/12 biscuits

A final score/weighted average greater than 3.0 is considered a failure.

Particle size distribution data for 200 mesh rice flour:

| | |
|---|---|
| Midpoint, micrometers | 31.9 |
| Mean Diameter, micrometers | 36.7 |
| 90% of Volume, micrometers | 69.6 |
| 10% of Volume, micrometers | 8.1 |

Particle size distribution for control rice flour:

| | |
|---|---|
| Midpoint, micrometers | 161.3 |
| Mean Diameter, micrometers | 163.6 |
| 90% of Volume, micrometers | 310.2 |
| 10% of Volume, micrometers | 21.0 |

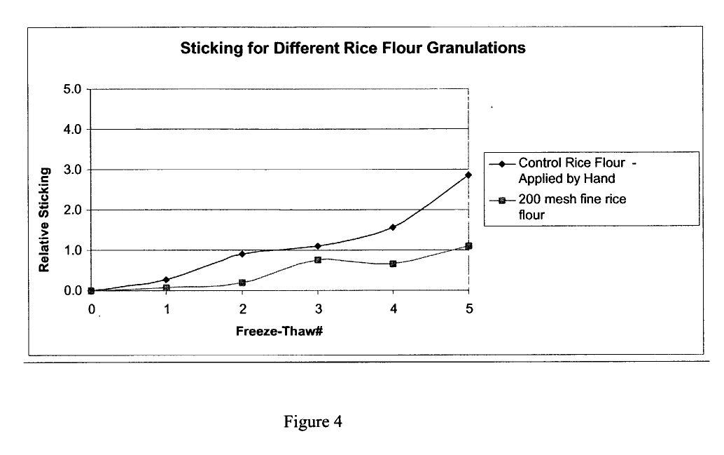

FIG. 4 shows results.

1. A method of preventing contacting surfaces of frozen dough from sticking together, the method comprising disposing an anti-stick material on one or more of the contacting surfaces, the anti-stick material comprising edible powder having an average particle diameter in the range from 5 microns to 160 microns.

2. The method of claim 1 wherein the edible powder comprises a flour, a starch, or a combination of a flour and a starch.

3. The method of claim 1 wherein the anti-stick material consists essentially of edible powder selected from the group consisting of: a flour, a starch, or a combination of a flour and a starch.

4. The method of claim 1 wherein the anti-stick material consists of edible powder selected from the group consisting of: a flour, a starch, or a combination of a flour and a starch.

5. The method of claim 1 wherein the anti-stick material consists essentially of rice flour.

6. The method of claim 1 wherein the edible powder comprises rice flour having an average particle diameter from 5 to 90 microns.

7. The method of claim 1 wherein the anti-stick material comprises edible powder and oil.

8. The method of claim 7 wherein the oil is selected from the group consisting of a liquid fat, shortening, and combinations thereof.

9. The method of claim 1 wherein the anti-stick material consists essentially of rice flour having an average particle diameter from 5 to 90 microns, and oil.

10. The method of claim 1 wherein the anti-stick material consists of rice flour having an average particle diameter from 5 to 90 microns, and oil.

11. The method of claim 1 wherein the edible powder is rice flour having an average particle diameter in the range from 5 to 160 microns, a median particle diameter in the range from 5 to 160 microns, a diameter of 90 percent by volume of the powder particles of less than 320 microns, and a diameter of 90 percent by volume of the powder particles of greater than 5 microns.

12. The method of claim 1 wherein the edible powder is rice flour having an average particle diameter in the range from 5 to 40 microns, a median particle diameter in the range from 5 to 40 microns, a diameter of 90 percent by volume of the powder particles of less than 70 microns, and a diameter of 90 percent by volume of the powder particles of greater than 5 microns.

13. The method of claim 1 wherein the dough is frozen biscuit dough.

14. The method of claim 1 wherein the edible powder is rice flour, the method comprising
freezing the dough,
disposing the rice flour on two surfaces of frozen dough, and
packaging the dough so the two surfaces contact each other.

15. A frozen food product comprising two contacting dough surfaces, one or more of the surfaces comprising anti-stick material comprising edible powder having an average particle diameter in the range from 5 microns to 160 microns.

16. The product of claim 15 wherein the anti-stick material reduces sticking of the two frozen dough surfaces to each other.

17. The product of claim 15 wherein the dough is frozen biscuit dough.

18. The product of claim 17 comprising multiple biscuits loosely packaged in a bag, with dough surfaces that contact other dough surface having anti-stick material disposed thereon.

19. The product of claim 15 wherein the anti-stick material is rice flour having an average particle diameter from 5 microns to 90 microns, and wherein 0.01 to 0.05 grams per square inch of the rice flour is coated on adjacent contacting dough surfaces.

20. The product of claim 15 wherein the edible powder comprises a flour, a starch, or a combination of a flour and a starch.

21. The product of claim 15 wherein the edible powder is rice flour having an average particle diameter from 5 microns to 50 microns.

22. The product of claim 15 wherein the edible powder is rice flour having
a midpoint particle diameter in the range from 5 to 160 microns,
a mean particle diameter in the range from 5 to 160 microns,
a diameter of 90 percent by volume of the powder particles of less than 320 microns, and
a diameter of at least 90 percent by volume of the powder particles of greater than 5 micron.

23. A frozen dough product comprising
dough composition, and
edible powder disposed on a surface of the dough composition to reduce sticking between the surface of the dough composition and another surface of dough composition, the edible powder having an average particle diameter in the range from 5 microns to 160 microns.

24. The dough product of claim 23 wherein the dough composition is a sheeted dough composition.

25. The dough product of claim 23 wherein the dough composition is a frozen biscuit.

26. The dough product of claim 23 wherein the edible powder comprises rice flour having an average particle diameter from 5 to 90 microns.

27. The dough product of claim 26 wherein the average particle diameter is from 5 to 50 microns.

28. The dough product of claim 26 wherein the average particle diameter is from 5 to 40 microns.

29. A method of preparing a frozen dough product, the method comprising
preparing a dough composition,
disposing anti-stick material comprising edible powder on one or more surfaces of the dough composition, the edible powder having an average particle diameter in the range from 5 to 160 microns, and
freezing the dough product.

30. The method of claim 29 wherein the dough is frozen, and the anti-stick material is disposed onto a frozen dough surface.

31. The method claim 29 wherein the anti-stick material is disposed onto the dough surface before freezing, and then the dough composition is frozen.

32. The method of claim 29 wherein the anti-stick material contains rice flour and 0.5 to 7 parts by weight oil per total weight rice flour and oil.
